(19) United States
(12) Patent Application Publication
(10) Pub. No.: US 2012/0192735 A1
(43) Pub. Date: Aug. 2, 2012

(54) FOUNTAIN SOLUTIONS FOR OFFSET LITHOGRAPHIC PRINTING INKS

(76) Inventors: Ramasamy Krishnan, North Brunswick, NJ (US); Jeff Jones, Chicago, IL (US); Jeff Newton, Oswego, IL (US); Donald C. Henderson, Loveland, OH (US)

(21) Appl. No.: 13/446,032

(22) Filed: Apr. 13, 2012

Related U.S. Application Data
(63) Continuation of application No. PCT/US2011/058763, filed on Nov. 1, 2011.
(60) Provisional application No. 61/408,772, filed on Nov. 1, 2010.
(60) Provisional application No. 61/448,374, filed on Mar. 2, 2011.

(51) Int. Cl. B41F 7/02; C09K 13/00

(52) U.S. Cl. 101/142; 101/450.1; 252/79.1

(57) ABSTRACT

A fountain solution for offset lithographic printing ink includes water, one or more surfactants, and a dynamic surface tension of less than 30 dynes/cm. The fountain solution can further include an interfacial tension between the fountain solution and the offset lithographic printing ink of less than 10 dynes/cm. The press waste of a print run applying the fountain solution is reduced to less than 5%. An offset lithographic printing system includes a fountain solution and an offset lithographic printing ink, and the press waste of the offset lithographic printing system is less than 5%.

This application claims the benefit of U.S. Provisional Patent Applications Nos. 61/408,772, filed on Nov. 1, 2010, and 61/448,374, filed on Mar. 2, 2011, both of which are hereby incorporated by reference for all purposes as if fully set forth herein.

### FIELD OF INVENTION

The present invention relates to fountain solutions and fountain etches for offset lithographic printing inks, more specifically to fountain solutions and fountain etches, which improves dampening feedrate efficiency, improves non-image area protection, and reduces printing waste.

### BACKGROUND OF THE INVENTION

Offset printing is a printing technique in which the inked image is transferred (or “offset”) from a plate to a rubber blanket, then to a printing substrate. Offset printing often is used in combination with a lithographic printing process, which is based upon competitive wetting of oil-based ink and water-based fountain solution for hydrophobic image areas and hydrophilic non-image areas on a printing plate. The oil base ink wets the hydrophobic image area while the fountain solution wets the hydrophilic non-image area. The role of the fountain solution is to protect the non-image area from ink which would in the absence of fountain solution completely wet the non-image areas. A condition where small amounts of ink are in the image area is referred to as “scumming” which is not an acceptable condition.

The printing plate is referred to as planographic because the image and non-image areas are in significantly the same plane unlike letterpress and flexographic printing processes where the image area is significantly raised above the non-image area. The image area usually consists of a low surface energy polymer which repeals water but is wet by oil-base ink. The non-image area is usually a high energy rough aluminum oxide with various proprietary treatments that is easily wet by both ink and fountain solution. Since fountain solution is attracted to the non-image area through strong polar attractions and weak non-polar attractions, fountain solution displaces the ink which only has weak non-polar attractions to the non-image area. Keeping the non-image area ink-free is the primary role of the fountain solution.

When an offset lithographic printing press is running, the fountain solution is continuously applied directly to the planographic plate or indirectly by emulsification in situ on the ink train just prior to the printing plate. In the former case called direct dampening the application of the ink is immediately after the application of the fountain solution. A complete and uniform film of fountain solution prevents the subsequent application of ink from covering the planographic plate in the non-image area. The fountain solution and ink on the plate are then both transferred to the blanket and then to the printing substrate and the process repeats again.

Plain water in some rare cases may temporarily perform as a fountain solution, but aqueous fountain solutions of various components such as electrolytes, surfactants, buffers, and water-soluble polymers are required for good performance. These components promote plate wetting, uniform and efficient dampening feedrate and fountain solution uniformity, as well as controlling the interaction of the fountain solution with the ink and the substrate. Dampening feedrate is usually controlled by adjusting the rotation rate of the dampening roller and the rotation setting is called fountain notches. Prints prefer fountain solutions that yield acceptable prints over a large range of notches.

A fountain solution is generally made from a fountain etch (often called “concentrate”) and ion-treated water for most web applications, and optionally alcohol or an alcohol substitute for certain web applications. The fountain etch typically includes about 40-80% by weight water and other select components (e.g., gums, synthetic polymers, complex sugars, surfactants, solvents, acids and buffering agents, desensitizing agents, biocides, non-piling agents, and chelating agents). The surfactants and alcohol or alcohol substitutes act to promote non-image area wetting and efficient dampening feedrate by lowering the surface tension of water to make the fountain solution spread more uniformly across non-image area of the printing plate and create thicker more uniform films on the dampening roller. Typically, the fountain etch is diluted with water to about 3-6 wt % concentration of the fountain etch to make a press ready fountain solution.

Times where the press is idle for quality issues is known in the field as “downtime.” Downtime typically includes three specific junctures: (1) during “make-ready”, which is the initial startup phase of the printing process; (2) re-starts following work stoppages due to various reasons, such as blanket washes, water window tests, repairs, work shift stoppages, etc.; and (3) during the print run if print quality is out of specification. Prints seek to minimize downtime as it results in decreased productivity, and paper, ink, and fountain solution waste. There is an environmental impact to the additinal waste as the press adjustments made to make an acceptable product can potentially lead to large volumes of wasted impressions. Cumulatively, these waste impressions can add up to large quantities of discarded ink and substrate.

In a recent study of web offset heat-set printing onto paper substrates, it was found that over 80% of the cost of printing arises due to paper. Of the paper costs involved, up to 15% or more is due to press-generated waste. Accordingly, there is a need to develop fountain solutions for offset lithographic printing, which improve printing efficiency and reduce printing waste.

### SUMMARY OF THE INVENTION

An advantage of the present invention is to provide a fountain solution for an offset lithographic printing ink. The fountain solution includes water, one or more surfactants, and a dynamic surface tension of less than 30 dynes/cm. The fountain solution can further include an interfacial tension between the fountain solution and the offset lithographic printing ink of less than 10 dynes/cm. The fountain solution can be an aqueous dilution of a fountain etch. The dynamic surface tension can be measured at a surface age of 0.1 second and at 5 wt % concentration of the fountain etch. The interfacial tension can be measured at a surface age of 100 seconds and at 5 wt % concentration of the fountain etch.

Another advantage of the present invention is to provide a fountain solution for an offset lithographic printing ink. The sum of two times the dynamic surface tension of the fountain solution and the interfacial tension between the fountain solution and the offset lithographic printing ink is less than 64 dynes/cm. The fountain solution can be an aqueous dilution of a fountain etch. The dynamic surface tension and the interfacial tension can be measured at a surface age of 1 second and at 6 wt % concentration of the fountain etch.

Yet another advantage of the present invention is to provide a fountain solution for an offset lithographic printing ink. The sum of two times the dynamic surface tension of the fountain solution and the interfacial tension between the fountain solution and the offset lithographic printing ink is less than 78 dynes/cm. The fountain solution can be an aqueous dilution of a fountain etch. The dynamic surface tension and the interfacial tension can be measured at a surface age of 1 second and at 3 wt % concentration of the fountain etch.

Yet another advantage of the present invention is to provide a fountain dispersion. The fountain dispersion includes water, one or more surfactants, and a turbidity of greater than 20 NTUs. The fountain dispersion can be an aqueous dilution of a fountain etch. The turbidity can be measured at 3 wt % concentration of the fountain etch.

Yet another advantage of the present invention is to provide a method for offset lithographic printing. The method includes providing a fountain solution and reducing the press waste of the offset lithographic printing to less than 5% by applying the fountain solution. The fountain solution includes water and one or more surfactants.

Yet another advantage of the present invention is to provide an offset lithographic printing system including a fountain solution and an offset lithographic printing ink, and the press waste of the offset lithographic printing system is less than 5%.

Yet another advantage of the present invention is to provide an offset lithographic printing system including a fountain dispersion and an offset lithographic printing ink, and the press waste of the offset lithographic printing system is less than 5%.

The one or more surfactants can be ethoxylated linear alcohols, ethoxylated alkyl phenols, fatty acid esters, amine/amide derivatives, alkylpolyglucosides, ethleneoxide/propyleneoxide copolymers, polyalcolols, ethoxylated polyalcohols, thiols (mercaptans), or thiol derivates. The one or more surfactants can be octyl pyrrolidone or alkyl thio ether. The fountain solution can further include a hydrotrope. The hydrotrope can be sodium alkyl sulfate, sodium toluene sulfonate, sodium xylene sulfonate, sodium cumene sulfonate, sodium terpene sulfonates, ammonium toluene sulfonate, ammonium xylene sulfonate, ammonium cumene sulfonate, tetrabutyl ammonium hydrogen sulfate, tetraphenyl phosphonium bromide, tetrabutyl ammonium bromide, sodium thiocyanate or mixtures thereof. The hydrotrope can be sodium ethylhexyl sulfate.

It is to be understood that both the foregoing general description and the following detailed description are exemplary and explanatory and are intended to provide further explanation of the invention as claimed.

### BRIEF DESCRIPTION OF THE DRAWINGS

The accompanying drawing, which is included to provide a further understanding of the invention and is incorporated in and constitutes a part of this specification, illustrate embodiments of the invention and together with the description serve to explain the principles of the invention.

FIG. 1 is a chart that shows the comparison of waste impressions of printing Trials A-F.

### DETAILED DESCRIPTION

Reference will now be made in detail to embodiments of the present invention, example of which is illustrated in the accompanying drawing.

Surface tension is the intermolecular force of attraction between adjacent molecules, expressed in force per unit width, for example as dynes/centimeter (dynes/cm). When an aqueous surfactant solution is expanded such as the formation of a drop or a bubble the surface or interfacial tension is dynamic, that is not at equilibrium. The surface is a composite of new surface and old surface which for a spherical geometry works out to be 3/7 of the formation time which is referred to as surface age. In diffusion controlled kinetics the state of equilibrium is defined by surfactant's diffusion coefficient, the desorption coefficient, the bulk viscosity, and the bulk surfactants concentration. As the surface ages the surface/interfacial tension decreases until equilibrium is obtained where the adsorption rate equals the desorption rate and the equilibrium or static surface tension is obtained.

Dynamic surface tension can be measured by a conventional method known to a person of ordinary skill in the print art. In this invention, the dynamic surface tension is measured using a Kruss DSA 100 (drop shape analysis system) with a pendant drop method or using a Tracker pendent drop tensiometer at room temperature and at a certain surface age. In offset lithographic printing processes, the fountain etch is typically diluted with deionized water to about 3 to 6 wt % based on the weight of the diluted fountain etch (also called “fountain solution”) before being applied to or used in the offset lithographic printing process. The dynamic surface tension of the fountain solution refers to the dynamic surface tension of the diluted fountain etch (3 to 6 wt %).

Interfacial tension is the surface tension between two phases, usually liquid-liquid or liquid-solid. For example, the interfacial tension between a fountain solution and an offset lithographic printing ink is the dynamic surface tension between the fountain solution and the offset lithographic printing ink, or the ink and the image area of a printing plate. In this invention, the interfacial tension is measured using a Kruss DSA 100 (drop shape analysis system) with a pendant drop method or using a Tracker pendent drop tensiometer at room temperature and at a certain surface age. In this invention, the interfacial surface tension refers to the interfacial tension between the diluted fountain etch (3 to 6 wt %) and the offset lithographic printing ink. When measuring the interfacial tension, the offset lithographic printing ink is diluted to 5 wt % ink with an oil. The oil can be, for example, Magie 470 oil. Because the interfacial surface tension between the diluted fountain etch (3 to 6 wt %) and the offset lithographic printing ink is close to the interfacial surface tension between the diluted fountain etch (3-6 wt %) and Magie 470 oil, Magie 470 oil can used in stead of an offset lithographic printing ink when measuring the interfacial tension.

Each time a printing press is halted for any reason, it requires a subsequent startup process to adjust press settings such that prints with acceptable quality are once again being produced. In addition to routine press stoppages, the press is typically stopped periodically during a print run to perform water window tests to help maintain print quality. Water settings are lowered until signs of scumming are seen on the printed sheet. Then the water settings are raised till the density is no longer acceptable. Water window is the dampening setting difference between the scumming point and the washout point. The scumming point is obtained by lowering the dampening feed setting until signs of scumming are seen on the printed sheet. The washout point is obtained by increasing the dampening feedrate until the optical density drops rapidly.

It has now been found that when one or more surfactants and/or a hydrotrope are added to a fountain etch, the dynamic surface tension of the 5 wt % diluted fountain etch with deionized water (fountain solution) is less than 30 dynes/cm at a surface age of 0.1 second, and the interfacial tension between the fountain solution and a lithographic ink is less than 10 dynes/cm at a surface age of 100 seconds. Using this fountain solution in an offset lithographic printing process results in the fewer combined impressions for the two stoppages to restore the print quality. The press waste of a print run is reduced to less than 5%. In this application, the press waste is expressed as a percentage of the impressions attributed to initial start up (“make ready”) and restarts to the total impressions in the print run. It is proposed that the low surface tension promotes efficient feed through the dampening system and an even film on the non-image areas of the printing plate, and the low interfacial tension between the fountain solution and the offset lithographic printing ink leads to faster kinetics of emulsification.

It also has been found that when one or more surfactants and/or a hydrotrope are added to a fountain etch, the dynamic surface tension of the fountain etch at a surface age of 1 second is less than 30 dynes/cm. The sum of two times the dynamic surface tension of the fountain solution and the interfacial tension between the fountain solution and the lithographic ink (Magie 470 oil) is less than 64 dynes/cm at 6 wt % concentration of the fountain etch and at surface age of 1 second, and is less than 78 dynes/cm at 3 wt % concentration of the fountain etch and at surface age of 1 second. The sum of two times the dynamic surface tension of the fountain solution and the interfacial tension describes a system of properties that result in efficient feedrate, more uniform plate wetting, and faster emulsification. Using this fountain solution in an offset printing process results in the fewer combined impressions for the two stoppages to restore the print quality. The press waste of a print run is reduced to less than 5%.

It also has been found that when the fountain etch is diluted with deionized water to about 3 to 6 wt % based on the weight of the diluted fountain etch, the fountain etch forms a fountain dispersion with water. The turbidity of the fountain dispersion was measured. Specifically, the fountain dispersion (3 wt %) has a turbidity of greater than 10 NTUs (nephelometric turbidity units). Preferably, the fountain dispersion (3 wt %) has a turbidity of greater than 20 NTUs.

The surfactants for use in this invention are of nonionic type. Suitable nonionic surfactants include ethoxylated linear alcohols, ethoxylated alkyl phenols, fatty acid esters, amine/amide derivatives, alkylpolyglucosides, ethleneoxide/propyleneoxide copolymers, polyalcolols, ethoxylated polyalcohols, thiols (mercaptans), and thiol derivates. Among these surfactants, octyl pyrrolidone and alkyl thio ether are particularly preferred. The amount of surfactants will range from 0.1% to 10% by weight based on the weight of the fountain etch.

The hydrotrope employed in this invention is an electrolyte with an inorganic and organic ion. The hydrotrope can assist in the solubilization of the nonionic surfactant in water. Suitable hydrotropes are those selected from the group consisting of sodium alkyl sulfate, sodium toluene sulfonate, sodium xylene sulfonate, sodium cumene sulfonate, sodium terpene sulfonates, ammonium toluene sulfonate, ammonium xylene sulfonate, ammonium cumene sulfonate, tetrabutyl ammonium hydrogen sulfate, tetraphenyl phosphonium bromide, tetrabutyl ammonium bromide, sodium thiocyanate and mixtures thereof. Among these surfactants, octyl pyrrolidone and alkyl thio ether are particularly preferred. The amount of hydrotrope will range from 0.1% to 10% by weight based on the weight of the fountain etch.

The fountain etch generally contains several other components. These components can include protective colloids, e.g., water-soluble gums, gum Arabic, cellulose gum. These polymers are generally used to help protect the non-image areas of a plate from contamination by ink and to maintain the area hydrophilic. In general, the amount of protective colloid will range from 0.5% to 15% by weight based on the weight of the fountain etch. Other components, which may be employed in the fountain etch, include biocides, corrosion inhibitors, anti-foaming agents, dyes, etc. The fountain etch can also contain an alcohol or alcohol substitute. The alcohol substitutes include ethylene glycol, propylene glycol, etc.

The fountain etch can also contain acids and buffering salts effective to maintain a desired pH. The fountain solutions are preferably used as aqueous acidic solutions having a pH of about 3.5 to 5.5. Phosphoric acid is commonly used in acidifying the formulation. Other acids include inorganic and organic acids, such as acetic acid, nitric acid, sulfuric acid, glycolic acid, citric acid, phthalic acid, malic acid and mixtures thereof. The buffering salts can include disodium hydrogen phosphate, dipotassium hydrogen phosphate, sodium hydrogen phthalate, potassium hydrogen phthalate, sodium dihydrogen phosphate, potassium dihydrogen phosphate, sodium acetate, sodium citrate, sodium glycolate, etc.

The addition of one or more surfactant and/or hydrotrope to a fountain etch resulting in lower dynamic surface tension and interfacial tension has resulted in a number of major advantages including less fountain solution usage, providing fast make-ready times on press, and reducing total press waste (substrate waste).

### Examples 1-8

Inks were prepared for testing by mixing the materials under a high speed mixer until homogenous. The composition of inks (shown in weight % based on the ink) is listed in Table 1.

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Material | Black | Cyan | Magenta | Yellow | Black | Cyan | Magenta | Yellow |
| Gilsonite | 20 | 0 | 0 | 0 | 0 | 0 | 0 | 0 |
| Gel vehicle | 0 | 0 | 14 | 25 | 24.8 | 16.5 | 35.5 | 37 |
| Insert vehicle | 18 | 48.3 | 32 | 24.8 | 11 | 21 | 0 | 0 |
| G80 vehicle | 7 | 7 | 7 | 7 | 8 | 10 | 7 | 10 |
| Clay compound | 0 | 0 | 0 | 0 | 0 | 0 | 0 | 5 |
| Black | 43 | 0 | 0 | 0 | 40 | 0 | 0 | 0 |
| Reflex Blue | 1.5 | 0 | 0 | 0 | 1.5 | 0 | 0 | 0 |
| Cyan | 0 | 31 | 0 | 0 | 0 | 39 | 0 | 0 |
| Sun Rubine | 0 | 0 | 35 | 0 | 0 | 0 | 22 | 0 |
| Apollo rubine | 0 | 0 | 0 | 0 | 0 | 0 | 21.5 | 0 |
| AAA Yellow | 0 | 0 | 0 | 24 | 0 | 0 | 0 | 33 |
| Orange | 0 | 0 | 0 | 0 | 0 | 0 | 0 | 0.2 |
| PTFE | 1.5 | 2.5 | 3 | 2.5 | 2 | 1.5 | 2.5 | 1.5 |
| Lanolin | 0 | 2 | 2 | 2 | 2 | 2 | 2 | 2 |
| Orange solid oil #3 | 2 | 0 | 0 | 0 | 0 | 0 | 2 | 0 |
| ARLO linseed oil | 1.5 | 1 | 1 | 1 | 0 | 2 | 0 | 0 |
| Castor oil | 1 | 0 | 0 | 0 | 0 | 0 | 0 | 0 |
| Tap water | 0 | 4 | 0 | 4 | 0 | 0 | 0 | 0 |
| Optilith 3 | 0 | 0 | 0 | 0 | 0.5 | 0.5 | 0 | 0 |
| TOFA | 0.2 | 0.2 | 0.2 | 0.2 | 0.2 | 0 | 0.2 | 0.2 |
| Magie 470 oil | 2.3 | 2 | 5.8 | 9.5 | 10 | 7 | 7.3 | 11.1 |
| Magie 500 oil | 2 | 2 | 0 | 0 | 0 | 0 | 0 | 0 |
| TXIB | 0 | 0 | 0 | 0 | 0 | 0.5 | 0 | 0 |
| Total | 100 | 100 | 100 | 100 | 100 | 100 | 100 | 100 |

A description of the above raw materials used to prepare the ink is listed in Table 2:

TABLE 2

| Material | Description |
|---|---|
| Gilsonite | Internal gilsonite varnish - mfg. Frankfort, IN |
| Gel vehicle | Internal gel vehicle - mfg. Hopkinsville, KY; 49% |
| | Phenolic modified rosin ester resin, 9% soy, ink oil, |
| | gellant |
| Insert vehicle | Internal gel vehicle - mfg. Hopkinsville, KY; 50% |
| | Phenolic modified rosin ester resin, ink oil, gellant |
| G80 vehicle | Internal soy gel vehicle - mfg. Hopkinsville, KY; 22% |
| | soy oil, 10% 140 melt hydro carbon, 42% Phenolic |
| | modified rosin ester resin, ink oil, gellant |
| Clay compound | 50% kaolin clay compound, internal mfg. Frankfort, IN |
| Black | Black base - internally mfg - Frankfort, IN; carbon black, |
| | HC varnish, ink oil, alkyd |
| Reflex Blue | CDR supplied |
| Cyan | Phthalo cyan flush - internal mfg. Muskegon, MI |
| Sun Rubine | Lithol rubine flush - internal mfg. Muskegon, MI |
| Apollo rubine | Lithol rubine flush - Apollo Colors |
| AAA Yellow | AAA Yellow 12 flush - internal mfg. Muskegon, MI |
| Orange | Orange base for toning ink - Apollo mfg. |
| PTFE | Wax compound for slip - Ethox Corp. |
| Lanolin | Wool grease |
| Orange solid | Gelled petroleum oil |
| oil #3 | |
| ARLO | |
| linseed oil | |
| Castor oil | |
| Tap water | |
| Optilith 3 | Emulsion stabilizer - Hexion |
| TOFA | Tall oil fatty acid - Unidyne 18; Arizona |
| Magie 470 oil | Petroleum oil - Calumet M470 |
| Magie 500 oil | Petroleum oil - Calumet 500 |
| TXIB | Plasticizer - Kodak Chemicals; 2,2,4 Tri-methyl |
| | diisobutyrate |

The inks are 4-color process printing inks, and were used in combination with a fountain solution in an offset lithographic printing process.

### Example 9

A fountain etch was formulated, and physically mixed until homogeneous. The composition is listed in Table 3.

TABLE 3

| Material | Purpose | wt % |
|---|---|---|
| Tap Water | — | 53.96 |
| Defoamer | Defoamer | 0.05 |
| Malic Acid | pH control | 1.62 |
| Disodium Phosphate | Cleans hard surfaces, impacts | 0.36 |
| (granular) | conductivity | |
| Sodium | Cleans hard surfaces, impacts | 0.20 |
| Hexametaphosphate (granular) | conductivity | |
| Sodium Acetate | pH control | 0.72 |
| Urea | Lubricates blanket by means of | 0.76 |
| | H-bonding | |
| Magnesium Nitrate (C) | Conductivity | 10.50 |
| Glycerine 99% | Lubricant/plate protector | 0.90 |
| Ethylene Glycol | Lubricant (alcohol replacement) | 3.60 |
| Propylene Glycol | Lubricant (alcohol replacement) | 2.70 |
| Glycol Ether EB | Solvent | 2.25 |
| Glycol Ether DB | Solvent | 7.20 |
| Niaproof 08 (Niacet) | Surfactant | 2.00 |
| Surfadone LP100 | Surfactant | 1.20 |
| Envirogem 360 | Surfactant | 1.58 |
| (Air Products) | | |
| Pure Gum Arabic | Gum | 9.50 |
| Amber Gum 3021 | Synthetic gum | 0.90 |
| (Hercules) | | |
| Total | — | 100.00 |

### Example 10

A fountain etch was formulated, and physically mixed until homogeneous. The composition is listed in Table 4.

TABLE 4

| Material | wt % |
|---|---|
| Tap Water | 50.58 |
| Dee Fo PI-75 (defoamer) | 0.05 |
| Malic Acid | 1.62 |
| Disodium Phosphate (granular) | 0.36 |
| Sodium Acetate | 0.72 |
| Urea | 0.76 |
| Magnesium Nitrate (C) | 10.50 |
| Glycerine 99% | 16.85 |
| Pure Gum Arabic | 9.50 |
| Amber Gum 3021 | 0.90 |
| Niaproof 08 | 5.50 |
| Envirogem 360 | 1.43 |
| Tetrasodium EDTA solution | 0.44 |
| BIO/TEC | 0.72 |
| Dye - Green dye Soln. | 0.07 |
| Total | 100.00 |

### Example 11

A fountain etch was formulated, and physically mixed until homogeneous. The composition is listed in Table 5.

TABLE 5

| Material | wt % |
|---|---|
| Tap Water | 51.43 |
| Dee Fo PI-75 (defoamer) | 0.05 |
| Malic Acid | 1.62 |
| Disodium Phosphate (granular) | 0.36 |
| Sodium Acetate | 0.72 |
| Urea | 0.76 |
| Magnesium Nitrate (C) | 10.50 |
| Glycerine 99% | 13.25 |
| Pure Gum Arabic | 9.50 |
| Amber Gum 3021 | 0.90 |
| Niaproof 08 | 7.60 |
| Envirogem 360 | 1.10 |
| Surfadone | 0.98 |
| Tetrasodium EDTA solution | 0.44 |
| BIO/TEC | 0.72 |
| Dye - Green dye Soln. | 0.07 |
| Total | 100.00 |

### Example 12

### Dynamic Surface Tension of 5 Wt % Concentration of Examples 9-11

The dynamic surface tension of Examples 9-11 (5 wt % concentration of the fountain etch) was measured at a surface age of 0.1 second at room temperature using a Kruss DSA 100 (drop shape analysis system) with a pendant drop method. The dynamic surface tension is listed in Table 6.

TABLE 6

| Fountain Solution | Dynamic Surface Tension |
|---|---|
| 5 wt % of Example 9 | 28 dynes/cm |
| 5 wt % of Example 10 | 29 dynes/cm |
| 5 wt % of Example 11 | 26 dynes/cm |

### Example 13

### Dynamic Surface Tension of 5 Wt % Concentration of Commercial Fountain Etches

Two commercial fountain solutions from Rycoline (ACFS 168 and ACFS 4600) were also tested for comparative purposes. The dynamic surface tension of ACFS 168 and ACFS 4600 (5 wt % aqueous dilution of fountain etch) was measured at a surface age of 0.1 second at room temperature using a Kruss DSA 100 (drop shape analysis system) with a pendant drop method. The dynamic surface tension is listed in Table 7.

TABLE 7

| Fountain | Dynamic Surface Tension |
|---|---|
| 5 wt % of ACFS 168 | 42 dynes/cm |
| 5 wt % of ACFS 4600 | 39 dynes/cm |

### Example 14

### Interfacial Tension Between Example 5 Ink and the Fountain Solutions

The interfacial tension between Example 5 Ink (diluted to 5 wt % ink with Magie 470 oil) and the above-described fountain solutions (at 5 wt % concentration) was measured at 100 seconds and at room temperature using a Kruss DSA 100 (drop shape analysis system) with a pendant drop method. Results are shown below in Table 8:

TABLE 8
Example 5 Ink

| Fountain Solution | Interfacial Tension |
|---|---|
| 5 wt % of ACFS 168 | 17 dynes/cm |
| 5 wt % of ACFS 4600 | 11 dynes/cm |
| 5 wt % of Example 9 | 8 dynes/cm |

### Example 15

### Interfacial Tension Between Example 6 Ink and the Fountain Solutions

The interfacial tension between Example 6 Ink (diluted to 5 wt % ink with Magie 470 oil) and the above-described fountain solutions (at 5 wt % concentration) was measured at 100 seconds and at room temperature using a Kruss DSA 100 (drop shape analysis system) with a pendant drop method. Results are shown below in Table 9:

TABLE 9
Example 6 Ink

| Fountain Solution | Interfacial Tension |
|---|---|
| 5 wt % of ACFS 168 | 18 dynes/cm |
| 5 wt % of ACFS 4600 | 12 dynes/cm |
| 5 wt % of Example 9 | 8 dynes/cm |

### Example 16

### Interfacial Tension Between Example 7 Ink and the Fountain Solutions

The interfacial tension between Example 7 Ink (diluted to 5 wt % ink with Magie 470 oil) and the above-described fountain solutions (at 5 wt % concentration) was measured at 100 seconds and at room temperature using a Kruss DSA 100 (drop shape analysis system) with a pendant drop method. Results are shown below in Table 10:

TABLE 10
Example 7 Ink

| Fountain Solution | Interfacial Tension |
|---|---|
| 5 wt % of ACFS 168 | 16 dynes/cm |
| 5 wt % of ACFS 4600 | 9 dynes/cm |
| 5 wt % of Example 9 | 7 dynes/cm |

### Example 17

### Interfacial Tension Between Example 8 Ink and the Fountain Solutions

The interfacial tension between Example 8 Ink (diluted to 5 wt % ink with Magie 470 oil) and the above-described fountain solutions (at 5 wt % concentration) was measured at 100 seconds and at room temperature using a Kruss DSA 100 (drop shape analysis system) with a pendant drop method. Results are shown below in Table 11:

TABLE 11
Example 8 Ink

| Fountain Solution | Interfacial Tension |
|---|---|
| 5 wt % of ACFS 168 | 16 dynes/cm |
| 5 wt % of ACFS 4600 | 10 dynes/cm |
| 5 wt % of Example 9 | 7 dynes/cm |

Tables 8-11 indicate that using Example 9 fountain solution with Examples 5-8 Inks provides an offset lithographic printing system with interfacial surface tension less than 10 dynes/cm.

### Example 18

### Dynamic Surface Tension of Examples 9-10 and Commercial Fountain Etches

The dynamic surface tension of Examples 9-10 and fifteen commercial fountain etches was measured using a Tracker pendent drop tensiometer under room temperature conditions of 22° C. at a surface age of 1 second. Table 12 shows the dynamic surface tension of Examples 9-10 and 15 commercial fountain etches.

TABLE 12

| | Dynamic Surface Tension |
|---|---|
| Fountain Etch | (dynes/cm) |
| Example 9 | 26.2 |
| Example 10 | 24.7 |
| Fugi Hunt | 25.5 |
| Anchor ProImage 3000 | 27.0 |
| CW 127 P | 27.4 |
| ACFS 561 | 22.9 |
| Nova-FS 708 | 24.6 |
| Varn 663 | 20.3 |
| Anchor 2912 | 27.6 |
| Print Easy 4600 FTN | 25.9 |
| Print Easy 4200 FTN | 25.1 |
| Sunfount H-480 SIE | 25.8 |
| Print Easy 4050 FTN | 25.7 |
| ACFS 168 | 25.8 |
| Varn 608 | 25.2 |
| Varn 606 | 24.8 |
| Varn Exp-141-98 | 27.3 |

### Example 19

### Sum of Two Times the Dynamic Surface Tension of the Fountain Solution and Interfacial Tension Between the Fountain Solution and Magie 470 Ink Oil

Examples 9-10 and fifteen commercial fountain etches were diluted to 6 wt % and 3 wt % with water. Using a 250 microliter syringe, an 18 gauge dropping needle whose exterior has a teflon sleeve to prevent creep, the dynamic surface tensions and dynamic interfacial tensions were determined on a Tracker pendent drop tensiometer under room temperature conditions of 22 degrees Celsius. The surface age (SA) was determined by use of the equation:

SA= 3/7*drop formation time+static hang time

The surface age for all the measurements in Example 19 is 1 second. The hanging drop used to calculate the dynamic surface tension was in a sealed cuvette to prevent significant evaporation during measurement. The hanging drop used for calculating interfacial tension was suspended in Magie 470 ink oil contained in a cuvette.

Table 13 shows the dynamic surface tension, interfacial tension and the resultant sum of two times the dynamic surface tension and interfacial tension.

TABLE 13

| | | | Sum of Two Times |
|---|---|---|---|
| | Dynamic | Interfacial | the Dynamic Surface |
| | Surface Tension | Tension | Tension and Interfacial |
| Fountain Solutions | (dynes/cm) | (dynes/cm) | Tension (dynes/cm) |
| 3 wt % of Example 9 | 28.8 | 16.3 | 73.8 |
| 3 wt % of Example 10 | 31.4 | 13.5 | 76.3 |
| 3 wt % of Fugi Hunt | 31.5 | 15.2 | 78.3 |
| 3 wt % of Anchor ProImage 3000 | 32.0 | 17.0 | 81.0 |
| 3 wt % of CW 127 P | 33.5 | 18.2 | 85.2 |
| 3 wt % of ACFS 561 | 33.8 | 25.5 | 93.1 |
| 3 wt % of Nova-FS 708 | 34.1 | 28.3 | 96.4 |
| 3 wt % of Varn 663 | 34.6 | 13.4 | 82.6 |
| 3 wt % of Anchor 2912 | 36.7 | 25.8 | 99.3 |
| 3 wt % of Print Easy 4600 FTN | 38.2 | 28.2 | 104.7 |
| 3 wt % of Print Easy 4200 FTN | 38.5 | 27.0 | 104.0 |
| 3 wt % of Sunfount H-480 SIE | 38.7 | 15.3 | 92.8 |
| 3 wt % of Print Easy 4050 FTN | 38.8 | 24.0 | 101.6 |
| 3 wt % of ACFS 168 | 39.4 | 26.1 | 104.8 |
| 3 wt % of Varn 608 | 40.8 | 27.4 | 109.0 |
| 3 wt % of Varn 606 | 42.3 | 26.0 | 110.7 |
| 3 wt % of Varn Exp-141-98 | 50.0 | 20.2 | 120.2 |
| 6 wt % of Example 9 | 26.1 | 11.2 | 63.5 |
| 6 wt % of Example 10 | 26.5 | 8.9 | 61.9 |
| 6 wt % of Fugi Hunt | 27.6 | 9.8 | 64.9 |
| Anchor ProImage 3000 | 27.6 | 13.5 | 68.8 |
| 6 wt % of CW 127P | 29.4 | 14.1 | 72.8 |
| 6 wt % of ACFS 561 | 26.2 | 18.0 | 70.4 |
| 6 wt % of Nova-FS 708 | 27.3 | 22.1 | 76.7 |
| 6 wt % of Varn 663 | 30.2 | 10.0 | 70.4 |
| 6 wt % of Anchor 2912 | 28.2 | 20.9 | 77.4 |
| 6 wt % of Print Easy 4600 FTN | 29.6 | 21.9 | 81.2 |
| 6 wt % of Print Easy 4200 FTN | 38.5 | 20.1 | 97.1 |
| 6 wt % of Sunfount H-480 SIE | 35.7 | 11.6 | 83.0 |
| 6 wt % of Print Easy 4050 FTN | 30.1 | 15.5 | 75.6 |
| 6 wt % of ACFS 168 | 30.9 | 19.9 | 81.6 |
| 6 wt % of Varn 608 | 33.1 | 18.6 | 84.8 |
| 6 wt % of Varn 606 | 34.9 | 18.6 | 88.5 |
| 6 wt % of Varn Exp-141-98 | 44.5 | 16.5 | 105.6 |

As shown in Table 13, 3 wt % and 6 wt % of Examples 9-10 have the lowest dynamic surface tension and sum of two times the dynamic surface tension and interfacial tension among the fountain solutions tested.

### Example 20

### Fountain Dispersion

Examples 9-10 and fifteen commercial fountain etches were diluted to 3 wt % with deionized water. All of the samples were measured for Turbidity using the Hach Model 2100P Portable Turbidimeter which operates on the nephelometric principle of turbidity measurement. Calibration of the instrument was performed using the supplied Gelex standards (10,100, and 1000 NTUs). The Turbidity data were shown in Table 14.

TABLE 14

| Fountain Dispersion | Turbidity (NTU) |
|---|---|
| 3 wt % of Example 9 | 454.0 |
| 3 wt % of Example 10 | 10.0 |
| 3 wt % of Fugi Hunt | 10.0 |
| 3 wt % of Anchor ProImage 3000 | 10.0 |
| 3 wt % of CW 127 P | 3.6 |
| 3 wt % of ACFS 561 | 3.0 |
| 3 wt % of Nova-FS 708 | 9.6 |
| 3 wt % of Varn 663 | 5.2 |
| 3 wt % of Anchor 2912 | 1.3 |
| 3 wt % of Print Easy 4600 FTN | 1.7 |
| 3 wt % of Print Easy 4200 FTN | 1.1 |
| 3 wt % of Sunfount H-480 SIE | 0.1 |
| 3 wt % of Print Easy 4050 FTN | 2.5 |
| 3 wt % of ACFS 168 | 1.1 |
| 3 wt % of Varn 608 | 4.0 |
| 3 wt % of Varn 606 | 5.6 |
| 3 wt % of Varn Exp-141-98 | 0.3 |

As shown in Table 14, 3 wt % of Examples 9-10 has highest Turbidity among all the samples tested.

### Example 21

### Fountain Solution Usage

Six combinations of Inks and fountain solution were tested for fountain usage in a printing process. The results are shown in Table 15 below:

TABLE 15

| TEST # | Ink Set | Fountain Solution | Fountain Usage |
|---|---|---|---|
| 1 | Examples 5-8 Inks | 5 wt % of ACFS4600 | 32.2% |
| 2 | Examples 5-8 Inks | 5 wt % of ACFS 168 | −12.3% |
| 3 | Examples 5-8 Inks | 5 wt % of Example 9 | −43.7% |
| 4 | Examples 1-4 Inks | 5 wt % of Example 9 | 0.6% |
| 5 | Examples 1-4 Inks | 5 wt % of ACFS 168 | −16.0% |
| 6 | Examples 1-4 Inks | 5 wt % of ACFS 4600 | base line set |

Negative (−) means less fountain solution was used compared to the standard base line set which is a combination of Examples 1-4 Inks and the ACFS4600 fountain solution. Test 3 represents a preferred embodiment in terms of fountain usage or consumption on press, but it is also clear that other combinations of inks and fountain solutions can be used to reduce the consumption of fountain solution on press

### Example 22

### Printing Efficiency

Six print trials were performed using the ink/fountain solution combinations described below on a Heidelberg M3000 web offset heat-set press printing onto paper substrate of 45# basis weight. Following stoppages, measurements were taken at two intervals to determine how many print impressions were required to restore the press to acceptable quality printing. The six trials use the following combination of ink set and fountain solutions.

Trial A: combination of Examples 5-8 Inks and 5 wt % of Example 9 fountain solution.

Trial B: combination of Examples 1-4 Inks and 5 wt % of Example 9 fountain solution.

Trial C: combination of Examples 1-4 Inks and 5 wt % of ACFS 168 fountain solution.

Trial D: combination of Examples 1-4 Inks and 5 wt % of ACFS 4600 fountain solution.

Trial E: combination of Examples 5-8 Inks and 5 wt % of ACFS 4600 fountain solution.

Trial F: combination of Examples 5-8 Inks and 5 wt % of ACFS 168 fountain solution.

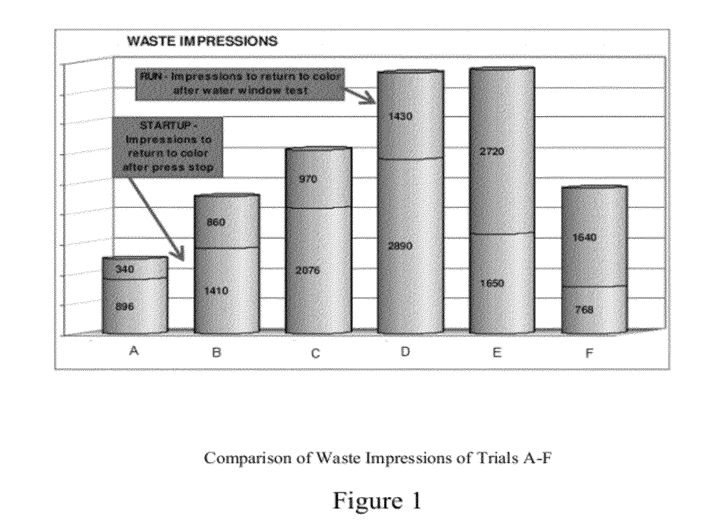

The results are shown in FIG. 1, which shows the actual number of impressions required at each of these two intervals to restore acceptable print quality. The first interval was a routine press stop which could be for any number of reasons (this is represented by the bottom portion of each bar on the graph denoted as “STARTUP” in FIG. 1). The second interval was a press stop to perform a water window test (this is represented by the top portion of each bar on the graph denoted as “RUN” in FIG. 1).

This data is shown in the form of a graph that illustrates the relative efficiency of each trial. To save time and minimize substrate waste, it is favorable to restore the press to acceptable print quality using the fewest possible number of test impressions (decreased time and waste). As can clearly be seen in FIG. 1, Trial A required the fewest combined impressions for these two stoppages to restore the print quality. This reduction in waste provides for faster print runs and improved environmental impact.

Additionally, a long-term 4-color process commercial print run was performed over the course of 6 months using a Goss Graphic M3000 high-speed press, producing approximately 25,000,000 impressions on a variety of papers from 30# news stock to 70# coated stock. The cumulative results are shown in Table 16 below:

TABLE 16
Printing Efficiency Based on % of Waste Impressions

| | | # of Waste |
|---|---|---|
| Ink and Fountain Solution combination | % Press Waste | Impressions |
| Examples 1-4 Inks + 5 wt % of | Discontinued - | |
| ACFS 168 | poor print | |
| | stability | |
| Examples 5-8 Inks + 5 wt % of | Discontinued - | |
| ACFS 168 | poor print | |
| | stability | |
| Examples 1-4 Inks + 5 wt % of | 7.6% | 1,900,000 |
| ACFS 4600 | | |
| Examples 5-8 Inks + 5 wt % of | 6.8% | 1,700,000 |
| ACFS 4600 | | |
| Examples 5-8 Inks + 5 wt % of | 2.8% | 700,000 |
| Example 9 | | |
| Examples 1-4 Inks + 5 wt % of | Discontinued - | |
| Example 9 | scumming | |

Waste results, expressed as a % total of all of the impressions, were attributed to initial start up (“make ready”) and restarts. Two of the combinations (Examples 1-4 Inks and 5 wt % of ACFS 168; and Examples 5-8 Inks and 5 wt % of ACFS 168) were found to be unsuitable for high-speed printing due to color stability problems and were discontinued. The combination of Examples 5-8 Inks and 5 wt % of Example 9 fountain solution was also discontinued due to scumming.

The lowest generation of waste (2.8%) for the exemplified system indicates more efficient print performance (fewer impressions and less time required to produce a predetermined number of acceptable quality impressions), and also a positive environmental impact due to reduced waste.

In addition, Table 16 exhibits the magnitude of improved efficiency and reduced waste that was realized by using the combination of Examples 5-8 Inks and 5 wt % of Example 9 fountain solution in a 25,000,000-impressions print run. The system including 5 wt % of Example 9 fountain solution generated more than 1 million fewer waste impressions than the two systems including commercial fountain solutions.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1-74. (canceled)

75. A fountain etch for offset lithographic printing comprising:
one or more surfactants;
water; and
less than about 8 wt. % of one or more hydrotopes.

76. The fountain etch according to claim 75, wherein said one or more hydrotopes is less than about 6 wt. % of said fountain etch.

77. The fountain etch according to claim 76, wherein said one or more hydrotopes is less than about 3 wt. % of said fountain etch.

78. The fountain etch according to claim 75, wherein said one or more hydrotopes comprises sodium ethylhexyl sulfate.

79. The fountain etch according to claim 75, exhibiting, when in a fountain solution, a dynamic surface tension less than or equal to about 31.4 dynes/cm measured at a surface age of 1 second.

80. The fountain etch according to claim 79, wherein said dynamic surface tension less than or equal to about 27.5 dynes/cm.

81. The fountain etch according to claim 79, exhibiting said dynamic surface tension at a concentration of about 3 to about 6 wt. % of said fountain etch in said fountain solution.

82. The fountain etch according to claim 80, exhibiting said dynamic surface tension at a concentration greater than about 3 to about 6 wt. % of said fountain etch in said fountain solution.

83. The fountain etch according to claim 75, exhibiting an interfacial tension between said fountain etch diluted in said fountain solution and an offset lithographic printing ink used in said offset lithographic printing less than about 17 dynes/cm measured at a surface age of about 1 second.

84. The fountain etch according to claim 83, wherein said interfacial tension is less than about 9.5 dynes/cm when measured at a surface age of about 1 second.

85. The fountain etch according to claim 75, exhibiting a turbidity greater than about 20 NTUs.

86. A fountain etch for offset lithographic printing comprising:
one or more surfactants; and
water;
wherein, when said fountain etch is diluted in a fountain solution, said fountain etch exhibits a dynamic surface tension less than or equal to about 27.5 dynes/cm measured at a surface age of 1 second.

87. The fountain etch according to claim 86, exhibiting said dynamic surface tension at a concentration greater than about 3 wt. % to about 6 wt. % of said fountain etch in said fountain solution.

88. The fountain etch according to claim 86, further comprising one or more hydrotopes less than about 8 wt. % of said fountain etch.

89. The fountain etch according to claim 88, where said one or more hydrotopes is less than about 6 wt. % of said fountain etch.

90. The fountain etch according to claim 89, where said one or more hydrotopes is less than about 3 wt. % of said fountain etch.

91. The fountain etch according to claim 88, wherein said one or more hydrotopes comprises sodium ethylhexyl sulfate.

92. The fountain etch according to claim 86, exhibiting an interfacial tension between said fountain etch diluted in said fountain solution and an offset lithographic printing ink used in said offset lithographic printing less than about 9.5 dynes/cm measured at a surface age of about 1 second.

93. A fountain solution comprising said fountain etch according to claim 75 and water.

94. A fountain solution comprising said fountain etch according to claim 86 and water.

95. A method of restoring printing quality and reducing a number of wasted substrates to less than about 5% of a six-month supply of original substrates for offset lithographic printing comprising:
providing a printing press including a printing plate;
applying a fountain solution to said printing plate;
applying a lithographic ink to said printing plate;
transferring said ink from said printing plate onto one of said original substrates.

96. An offset lithographic printing system comprising:
an offset lithographic printing press;
a fountain etch diluted in said fountain solution, said fountain etch including one or more surfactants, water and less than about 8 wt. % of one or more hydrotopes; and
an offset lithographic printing ink.

97. The system according to claim 96, wherein said one or more hydrotopes is less than about 6 wt. % of said fountain etch.

98. The system according to claim 97, wherein said one or more hydrotopes is less than about 3 wt. % of said fountain etch.

99. The system according to claim 96, wherein said one or more hydrotopes comprises sodium ethylhexyl sulfate.

100. The system according to claim 96, wherein said fountain etch diluted in said fountain solution exhibits a dynamic surface tension less than or equal to about 27.5 dynes/cm measured at a surface age of 1 second.

101. The system according to claim 100, exhibiting said dynamic surface tension at a concentration of about 3 to about 6 wt. % of said fountain etch in said fountain solution.

102. Use of the offset lithographic printing system according to claim 96 for web offset heat-set printing, sheetfed printing processes or energy curable offset printing processes.
